(19) United States
(12) Patent Application Publication
(10) Pub. No.: US 2021/0034956 A1
(43) Pub. Date: Feb. 4, 2021

(54) MINIMUM MEMORY DIGITAL CONVOLVER

(71) Applicant: Hysai Inc., Cottonwood Heights, UT (US)

(72) Inventors: Richard M. SWENSON, Las Vegas, NV (US); Robert A. LICKLIDER, Shelton, WA (US)

(21) Appl. No.: 16/836,443

(22) Filed: Mar. 31, 2020

Related U.S. Application Data
(60) Provisional application No. 62/879,747, filed on Jul. 29, 2019.

(51) Int. Cl. G06N 3/063

(52) U.S. Cl. CPC G06N 3/063

(57) ABSTRACT

An advancement over previous techniques, input data frames are streamed row-by-row to a convolver that can calculate and stream out convolution values without storing the convolution values. For many convolution operations only a single row of partial sums is stored. As input data values are received, they can be multiplied by kernel values and accumulated as partial sums until a convolution value is calculated. Convolution values can be clocked out of the convolver as soon as they are produced, thereby freeing the memory cell for use in calculating a different convolution sum. Clocking out convolution values as soon as they become available produces an output data stream of convolution values. By freeing memory cells and then reusing them as soon as possible, a convolver with a small, perhaps minimum, number of memory cells amount of memory is realized.

### CROSS REFERENCE TO RELATED APPLICATIONS

This patent application and claims the priority and benefit of U.S. provisional patent application No. 62/879,747, titled “MINIMUM MEMORY DIGITAL CONVOLVER,” filed on Jul. 29, 2019, which is herein incorporated by reference in its entirety.

### TECHNICAL FIELD

The embodiments herein relate to digital neural network circuitry, digital signal processing, image processing, and, more particularly, to specialized digital circuitry for convolving data streams with multidimensional kernels while conserving the number of memory cells required by the specialized digital circuitry.

### BACKGROUND

Convolution is a basic operation in digital signal processing and image processing. It is also a useful operation in neural networks. In the past, multidimensional convolutions have required large amounts of memory storing entire input frames of data. In such implementations, the number of operations performed has been treated as the critical value with fewer operations implying that the computed output is available sooner or that less energy has been consumed in producing the output. Advances have concentrated on parallel processing in which different areas or volumes of the input frame are operated on in parallel. The end result is that large and powerful convolution engines have been produced. While impressive, such hardware is only suited for applications, such as data centers, having the space, power, and cooling to support large specialized computing machines. Other applications require other solutions.

### BRIEF SUMMARY

It is an aspect of the embodiments that a minimum memory digital convolver can convolve an input stream of data with a kernel, sometimes called a convolution kernel. In its most basic two-dimensional form, the convolution equation is:

$${o}_{m , n} = {\sum }_{i = 0}^{W i - 1} {\sum }_{j = 0}^{W j - 1} {w}_{i , j} {f}_{m + i , n + j} \qquad ( 1 )$$

The input frame, F, is a two-dimensional array of numbers having Fi rows and Fj columns. The number at row m and column n of the input frame, F, is data value f_{m,n}. The output frame, O, is a two-dimensional array of numbers having Oi rows and Oj columns. The number at row m and column n of the output frame, O, is the convolution value o_{m,n}. The kernel, W, is a two-dimensional array of numbers having Wi rows and Wj columns. The number at row m and column n of the kernel, W, is the kernel value w_{m,n}. A partial sum is an intermediate value that is calculated while evaluating equation 1. For example, for a 3×3 kernel the first row partial sum, which is the partial sum for the first kernel row where i=0 in equation 1, is: w_{0,0}f_{m,n}+w_{0,1}f_{m,n+1}+w_{0,2}f_{m,n+2}. Similarly, the last row partial sum, where i=Wi−1 in equation 1 is: w_{wi-1,0}f_{m+wi-1,n}+w_{wi-1,1}f_{m+wi-1,n+1}+w_{wi-1,2}f_{m+wi-1,n+2}. Kernels, input frames, output frames, and other arrays are often referred to using their size in rows x cols. For example, a 3×3 kernel has Wi=3 rows and Wj=3 columns. As such, a 3×3 kernel comprises a first kernel row having the kernel values w_{0,x}, a second kernel row having the kernel values w_{1,x}, a third kernel row having the kernel values w_{2,x}, a first kernel column having the kernel values w_{x,0}, a second kernel column having the kernel values w_{x,1}, and a third kernel column having the kernel values w_{x,2}.

The input frame can be received as an input stream of data values. For purposes of illustration, the non-limiting examples discussed herein will treat the input stream as being clocked in row-by-row with row n of the input frame being received before row n+1. As such, data value f_{0,0} is received first, data value f_{0,1} is received second, and data value f_{Fi-1,Fj-1} is received last.

It is another aspect of the embodiments that a kernel store circuit can be configured to store a kernel comprising a plurality of kernel values, w_{m,n}, arranged as Wi rows of kernel values and Wj columns of kernel values, wherein Wi is greater than one because otherwise the kernel is one dimensional and, as such, the sum value store as discussed herein may be unnecessary. An arithmetic circuit can be configured to calculate a plurality of partial sums, each calculated using at least one data value and at least one of the plurality of kernel values, wherein the input stream of data comprises the at least one data value. A sum value store circuit can be configured to store the plurality of partial sums and to clock out a plurality of convolution values, wherein each one of the plurality of convolution values is calculated at least in part using a first row kernel value and a last row kernel value. A first row kernel value is a kernel value in the first row of the kernel. A last row kernel value is a kernel value in the last row of the kernel.

The input stream of data can be convolved with the kernel at a column stride of Sj, wherein the input stream of data comprises Fj columns of data values, and wherein the sum value store circuit contains no more than ceil(Fj/Sj) memory registers. “Ceil(value)” is a mathematical function that returns the smallest integer that is greater than or equal to value. Many application use int(Fj/Sj) memory registers where “int(value)” is a mathematical function that returns the largest integer less than or equal to value. For a column stride of Sj and a row stride of Si, equation 1 becomes:

$${o}_{m , n} = {\sum }_{i = 0}^{W i - 1} {\sum }_{j = 0}^{W j - 1} {w}_{i , j} {f}_{Si * m + i , Sj * n + j} \qquad ( 2 )$$

An input circuit can be configured to receive the input stream of data, the input stream of data comprising Fi rows of data values and Fj columns of data values, wherein the input stream of data is received row-by-row as a stream of data values. An output circuit can be configured to output the plurality of convolution values, wherein the plurality of convolution values comprises a plurality of first row partial sums and a plurality of last row partial sums, wherein the first row partial sums are calculated using a first kernel row, wherein the last row partial sums are calculated using a last kernel row, and wherein the plurality of first row partial sums overwrite the plurality of partial sums stored in the sum value store. The first kernel row consists of the kernel values w_{0,j} where j=0 to Wj−1. The last kernel row consists of the kernel values w_{Wi-1,j} where j=0 to Wj−1. A first row kernel value is a kernel value in the first kernel row. A last row kernel value is a kernel value in the last kernel row.

It is an aspect of the convolver that the last row partial sums might not be accumulated into the sum value store. As such, the partial sum stored in the sum value store can be added to a last row partial sum to produce a correlation value and that correlation value can be immediately clocked out of the convolver without being first stored in the sum value store circuit.

The convolver can have an input value store circuit configured to store the at least one data value, wherein the arithmetic circuit reads the at least one data value from the input value store circuit. In some embodiments, the input circuit can simply be a wire or wires carrying the input data value as a signal. For example, for an eight-bit input data value the input circuit can be eight wires, each at a specific voltage for “1” and a different voltage for “0”. An input value store can be one or more memory cells temporarily storing input data values. When using a memory cell, input data values can be latched into and held steady by the input value store circuit as an input to the arithmetic circuit. When an input value store circuit is available, the arithmetic circuit can be configured to calculate a plurality of partial sums, each calculated using at least one data value stored in the input value store circuit and at least one of the plurality of kernel values, wherein the input stream of data comprises the at least one data value. The input value store circuit configured to store exactly N data values at once has N memory cells and no more than N memory cells. The input value store circuit can be configured with N=1, a single memory cell, such that it can store only a single data value at a time. The input value store circuit can be configured with N=Sj such that it can store a stride, a stride being Sj data values.

For a convolver having an input value store circuit, a second arithmetic circuit can be configured to calculate a plurality of additional values comprising an additional value calculated using the kernel and at least one subsequent data value, wherein a first partial sum is calculated using the kernel and at least one preceding data value, wherein the at least one subsequent data value overwrites the at least one preceding data value in the input value store circuit, and wherein one of the plurality of convolution values is based at least in part on the first partial sum and the additional value. Using a 3×3 kernel as an example, the first partial sums can be w_{i,0fm+i,n}+w_{i,1fm+i,n+1} and the additional values can be w_{i,2fm+i,n+2}, where i can be the number of any of the kernel rows. The data values f_{m+i,n} and f_{m+i,n+1} are preceding data values of f_{m+i,n+2} because they were stored in the input value store circuit before f_{m+i,n+2} was stored in the input data store circuit and because f_{n+i,n+2} overwrote f_{m+i,n} or f_{m+i,n+1} in the input value store circuit. As an example, for an input value store circuit having only one memory cell, f_{m+i,n+1} overwrites f_{m+i,n} and, later, f_{m+i,n+2} overwrites f_{n+i,n+1}. Similarly, f_{m+i,n+2} is a subsequent data value of f_{m+i,n+i} which, in turn, is a subsequent data value of f_{m+i,n}.

For a convolver having an input value store circuit, the plurality of partial sums can be based at least in part on a first partial sum and an additional value, the first partial sum calculated using at least one preceding data value and the additional value calculated using at least one subsequent data value, wherein the at least one subsequent data value overwrites the at least one preceding data value in the input value store circuit.

The convolver can be designed for an input stream of data comprising Fi=1080 rows of data values and Fj=1920 columns of data values wherein the row stride Si=2, the column stride Sj=2, the kernel has Wi=3 rows, and the kernel has Wj=3 columns. As such, the sum value store circuit may have exactly 960 memory registers, also called memory cells. The input value store circuit can have Sj memory cells such that it can store a stride of data values at once. The input value store circuit may have no more than Sj memory cells such that it can store no more than a stride of data values. A stride of data values is Sj data values in a row, f_{i,j}, f_{i,j+1}, . . . , f_{i,Sj-1}. As such, the input value store circuit can be configured to sequentially store a plurality of strides, each stride comprising two data values. A plurality of first row partial sums can be calculated using the plurality of strides and the first two columns of the first kernel row. A plurality of second row partial sums can be calculated using the plurality of strides and the first two columns of the second kernel row. A plurality of last row partial sums can be calculated using the plurality of strides and the first two columns of the third kernel row. Each of the plurality of convolution values can be calculated using one of the first row partial sums, one of the second row partial sums, and one of the last row partial sums. The arithmetic circuit can calculate a plurality of additional values comprising an additional value calculated using the third kernel column and the first column of a plurality of subsequent strides. The arithmetic circuit can sum a first partial sum and an additional value calculated using a subsequent stride, wherein a first partial sum is calculated using a preceding stride, and wherein the subsequent stride overwrites the preceding stride in the input value store circuit.

For clarity, two-dimensional data frames, kernels, and output frames have been described thus far. Data frames and kernels can instead have three, four, or more dimensions. Two dimensional frames/kernels have been described as having rows and columns and to have the size “rows×columns”. For example, a data frame having 1920 columns and 1080 rows is a 1080×1920 data frame. The third dimension is often called a channel. A data frame having 1920 columns, 1080 rows, and 3 channels is a 1080×1920×3 (rows×columns×channels) data frame. The three-dimensional convolution equation can be written as:

$${o}_{m , n}^{l} = {\sum }_{i = 0}^{K i - 1} {\sum }_{j = 0}^{K j - 1} {\sum }_{k = 0}^{K k - 1} {w}_{m , n}^{k , l} {f}_{Si * m + i , Sj * n + j}^{k} \qquad ( 2 )$$

A three-dimensional kernel is sized Wi×Wj×Wk. A four-dimensional kernel is sized Wi×Wj×Wk×Wl. The variable “l” denotes the output channel number. Those practiced in linear algebra and multidimension mathematics are familiar with convolutions in four or more dimensions.

It is therefore a further aspect of the embodiments that a second kernel store circuit can be configured to store a second kernel channel; and third kernel store circuit can be configured to store a third kernel channel, wherein the input stream of data comprises a second input channel and a third input channel. The arithmetic circuit can be configured to produce a second plurality of partial sums based on the second kernel channel and the second input channel. The arithmetic circuit can also be configured to produce a third plurality of partial sums based on the third kernel channel and the third input channel. The second plurality of partial sums and the third plurality of partial sums can be added to the plurality of partial sums stored in the sum value store circuit.

It is yet another aspect of the embodiments wherein the kernel further comprises a kernel output channel, wherein a flattened output frame comprises a plurality of flattened output values, wherein each flattened output value is based at least in part on a first output channel value, a second output channel value, a third output channel value, and the kernel output channel.

With reference to the input channels, an embodiment can be made, wherein the input stream of data comprises a plurality of input channels, wherein the kernel comprises a plurality of kernel channels, wherein the kernel store circuit is configured to store the plurality of kernel channels, and wherein the arithmetic circuit is configured to produce the plurality of convolution values using each one of the plurality of input channels and each one of the plurality of kernel channels.

It is an aspect of the embodiments that a system can be configured for convolving an input stream of data with a kernel. The system can comprise a kernel store circuit. The kernel store circuit can be configured or sized to store a kernel comprising 3 rows of kernel values and 3 columns of kernel values. The system can comprise an arithmetic circuit and a sum value store circuit. The sum value store circuit can be configured to store a plurality of partial sums and to clock out a plurality of convolution values. The arithmetic circuit can calculate a plurality of row 0 partial sums using the stream of data and kernel row 0. The plurality of row 0 partial sums can be stored in the sum value store circuit by overwriting a previous plurality of partial sums previously stored in the sum value store circuit. The arithmetic circuit can calculate a plurality of row 1 partial sums using the stream of data and kernel row 1, wherein the plurality of row 1 partial sums is accumulated into to the plurality of partial sums stored in the sum value store circuit. The arithmetic circuit can calculate a plurality of row 2 partial sums using the stream of data and kernel row 2, wherein the plurality of row 2 partial sums is added to the plurality of partial sums to produce the plurality of convolution values. The system can be configured such that clocking out the plurality of convolution values is performed in parallel with storing a subsequent plurality of row 0 partial sums in the sum value store circuit.

The system can comprise an input circuit, a stride store circuit, and an output circuit. The input circuit can be configured to receive the input stream of data, the input stream of data comprising a plurality of input columns of data values. The stride store circuit can be configured to sequentially store a plurality of length two strides from the input stream of data, wherein a preceding stride is from input columns n and n+1, wherein a subsequent stride is from input columns n+2 and n+3, and wherein the subsequent stride overwrites the preceding stride stored in the stride store circuit. As discussed above, a stride store circuit can be an input value store circuit having Sj memory cells. The stride store circuit can provide the plurality of strides to the arithmetic circuit. The output circuit can be configured to output the plurality of convolution values. Recall that the input circuit can simply be a plurality of wires or can be circuitry that operates on input signals to produce the data values. Similarly, the output circuit can simply be a plurality of wires or can be circuitry that operates on convolution values to produce output signals. The plurality of input columns can be Fj input columns. Given Fj input columns and Sj=2, the sum value store circuit can be configured to store no more than ceil(Fj/2) partial sums at a time.

A still yet further aspect of the embodiments can be that one of the plurality of partial sums is based at least in part on a row 0 partial sum and an additional value, the row 0 partial sum calculated using a preceding stride and the additional value calculated using a subsequent stride, wherein the subsequent stride overwrites the preceding stride in a stride store circuit.

Still yet another aspect of the embodiments can be that the arithmetic circuit is configured to add an additional value to a partial sum, the partial sum calculated using a preceding stride, the additional value calculated using a subsequent stride that overwrites the preceding stride in a stride store circuit.

### BRIEF DESCRIPTION OF THE FIGURES

The embodiments herein will be better understood from the following detailed description with reference to the drawings, in which:

FIG. 1 is a high-level block diagram of a minimum memory convolver that can convolve an input data stream with a kernel, according to embodiments disclosed herein;

FIG. 2 illustrates convolution footprints for a 3×3 kernel, a 7×7 input frame, a column stride of 2, and a row stride of 2, according to embodiments disclosed herein.

FIG. 3, which includes FIGS. 3A-3C, illustrate operations performed by a minimum memory convolver producing convolution values, according to embodiments disclosed herein;

FIG. 4 is a high-level block diagram of a multi-channel minimum memory convolver in operation, according to embodiments disclosed herein;

FIG. 5 illustrates partial cum calculations for the multi-channel minimum memory convolver of FIG. 4, according to embodiments disclosed herein;

FIG. 6 illustrates a multi-channel minimum memory convolver with one output channel that sums the output of three minimum memory convolvers, according to embodiments disclosed herein;

FIG. 7 illustrates a multi-channel minimum memory convolver with multiple output channels, according to embodiments disclosed herein;

FIG. 8 illustrates a high-level block diagram of a minimum memory convolver with one sum value store circuit, according to embodiments disclosed herein;

FIG. 9 illustrates a high-level block diagram of a minimum memory convolver with two sum value store circuits, according to embodiments disclosed herein;

FIG. 10 a high-level block diagram of a minimum memory convolver with one sum value store circuit processing multiple input channels, according to embodiments disclosed herein;

FIG. 11 illustrates an S2 (3, 3, 1, 1) minimum memory convolver, according to embodiments disclosed herein;

FIG. 12 illustrates an S2 (3, 3, 3, 1) minimum memory convolver, according to embodiments disclosed herein;

FIG. 13 illustrates an S2 (3, 3, 3, 16) minimum memory convolver, according to embodiments disclosed herein;

FIG. 14 illustrates an S1 (3, 3, 1, 1) minimum memory convolver, according to embodiments disclosed herein;

FIG. 15 illustrates an S1 (3, 3, 32, 1) minimum memory convolver, according to embodiments disclosed herein;

FIG. 16 illustrates an S1 (3, 3, 32, 3) minimum memory convolver, according to embodiments disclosed herein;

FIG. 17 illustrates a single cell input value store circuit and two arithmetic circuits processing data values, according to embodiments disclosed herein;

FIG. 18 illustrates a two-cell input value store circuit and two arithmetic circuits processing data values, according to embodiments disclosed herein; and

FIG. 19 illustrates a system diagram of a minimum memory convolver printed circuit board (PCB) having a minimum memory convolver integrated circuit (IC).

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Convolutions are K[W·F], where K operates on a linear product of a kernel W and an input frame F. In the digital realm, W can have four dimensions. The first two dimensions are the number of kernel rows, Wi and, and the number of kernel columns, Wj. Wi and Wj are typically small compared to the number of input frame rows Fi and input frame columns Fj. The other two dimensions of W can be the number of input channels Wk and output channels Wl. W can therefore be a four-dimensional array of size Wi×Wj×Wk×Wl. An individual number in W, w_{m,n}^{k,l}, can be called a weight or kernel value. Note that the superscripted k and l are indexes into the kernel and do not indicate exponentiation. The input frame F can have three dimensions: Fi rows, Fj columns, and Fk channels. Thus, a digital 1080p RGB stream has Fi=1080 rows, Fj=1920 columns, and Fk=3 channels. An individual number in F, f_{i,j}^{k}, can be called a data value or an input frame value.

A digital convolution can be described with summations, with each kernel value multiplying an input in a sum of products. The sum occurs over the first three dimensions of W, Wi, Wj, and Wk. For the 1080p example, a 3×3 kernel can be used, indicating Wi=Wj−3. For this example, a single input channel (Wk=1) and single output channel (Wl=1) can be used.

The output of the convolution is another array, the output frame O. An individual number in O, o_{m,n}^{l} with planar indices m and n and output channel l, can be called a convolution value. Convolution stride Si and Sj indicate positional shifts of the kernel for each convolution. The output frame is given above by Equation (2). The output frame O has Oi rows, Oj columns, and Ok channels. Oi, Oj, and Ok are generally different from Fi, Fj, and Fk. The size of O can depend on the size of F, the size of K, the row stride Si, and the column stride Sj. The number of output channels is dependent on the application.

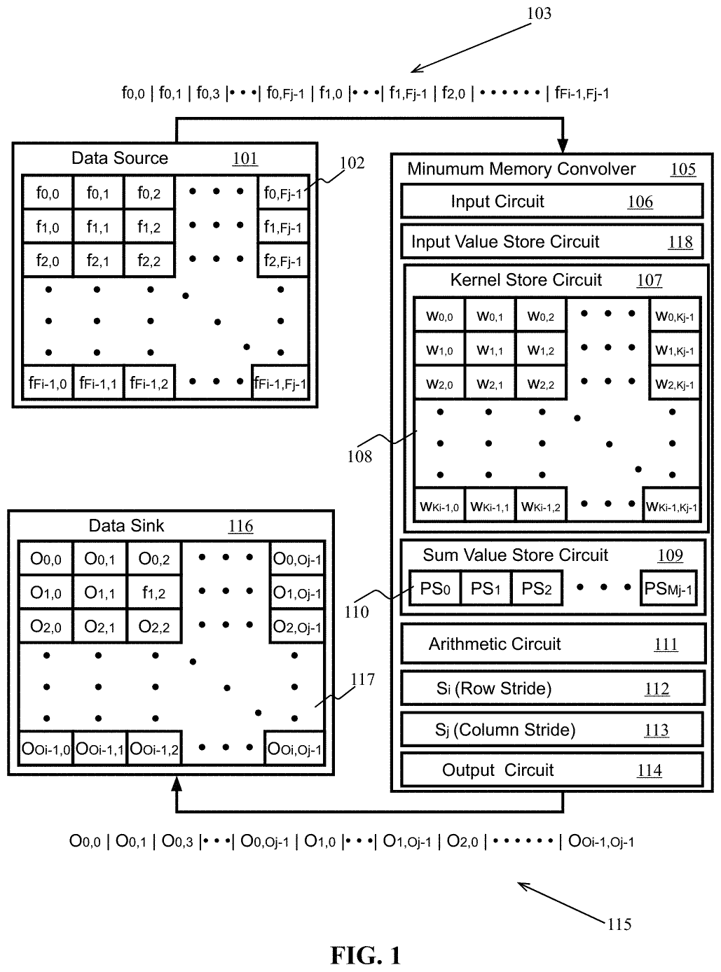

FIG. 1 is a high-level block diagram of a minimum memory convolver 105 that can convolve an input stream of data values 103 with a kernel 108, according to embodiments disclosed herein. A data source 101 can stream an input frame 102 to the minimum memory convolver 105 as a stream of data 103. The data values in the input frame can be streamed row-by-row with row f_{0,x} being streamed first, row f_{1,x} being streamed second and row f_{Fi-1,x} being streamed last. The first data value in the input stream of data 103 is f_{0,0}. The last value in the stream of data 103 is f_{Fi-1,Fj-1}.

The minimum memory convolver 105 can have an input circuit 106, an input value store circuit 118, a kernel store circuit 107, a sum value store circuit 109, an arithmetic circuit 111, a row stride 112, a column stride 113, and an output circuit 114. The input stream of data 103 can enter the minimum memory convolver 105 through the input circuit 106. Some embodiments can have an input value store circuit 118 that can store one or more data value for use by the arithmetic circuit 111. For example, the input value store circuit can latch a data value when a clock signal indicates that a new data value is stable on the input circuit 106. In such a manner, the entire input stream 103 can be sequentially clocked into the minimum memory convolver with the input value store circuit providing a stable output to the arithmetic circuit. Applications wherein the input data values are stable at the input circuit 106 may not require an input value store circuit 106.

The arithmetic circuit can calculate partial sums by multiplying one or more kernel values 108 with one or more data values from the input data stream 103. The multiplication products can be accumulated and stored in the sum value store circuit 109. The sum value store circuit 109 has PS_{Mj-1} memory cells 110 and can be specifically sized for an application. For example, an application in which the input frame has Fj=1920 columns and wherein the column stride Sj=2 can have Mj=Fj/Sj=960 memory cells. The memory cells can be sized to store a specific size of unsigned integer (uint), integer, or floating-point value. The simplest hardware can result from applications in which all values are unsigned integers.

The kernel store circuit 107 can store an entire kernel or can store a single kernel channel. The embodiments described herein are ideally suited for implementation on custom hardware or as an application specific integrated circuit (ASIC) chip or ASIC module on a chip. An application in which a 3×3 kernel is convolved with the input frame can have a kernel store circuit with nine memory cells. The kernel can be stored in the memory cells. Alternatively, for a specific application the kernel values could be permanently set in the convolver circuitry.

The row stride Si and the column stride Sj can be stored as values in memory cells or can be aspects of the circuitry. A minimum memory convolver 105 can be designed and built for a specific application having a predetermined row stride Si and a predetermined column stride Sj. As such, the circuitry itself can be designed to produce convolution results having the predetermined row stride and column stride.

The output frame 117 an be streamed out of the output circuit of the minimum memory convolver 105 as a stream of output data values 115 or convolution values 115. The stream of convolution values 115 can be streamed to a data sink 116 that can store or further process the output frame 117. For example, the output stream 117 can be the input stream of data for another minimum memory convolver.

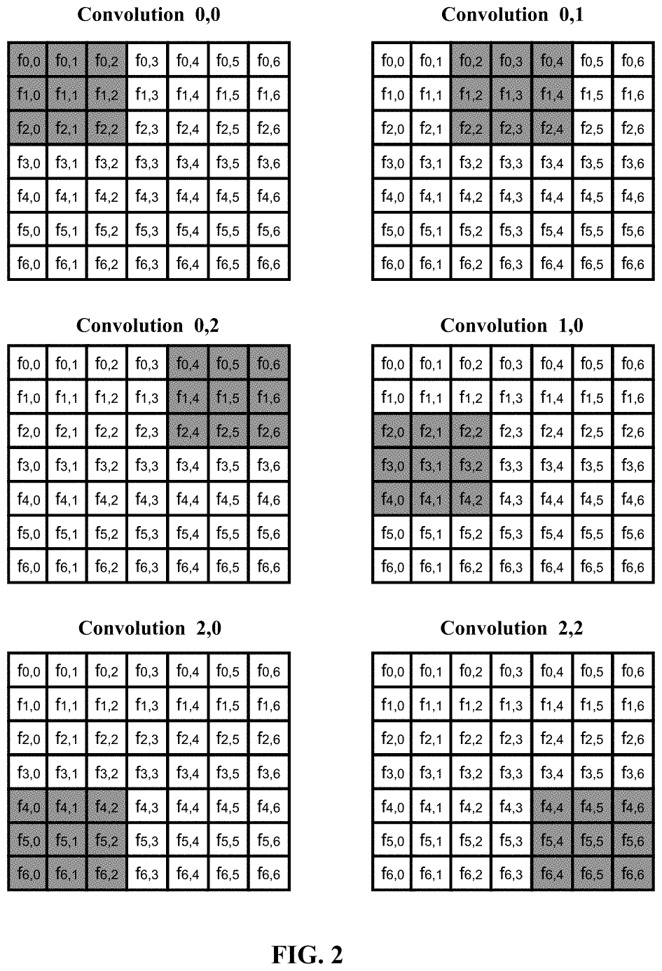

FIG. 2 illustrates convolution footprints for a 3×3 kernel, a 7×7 input frame, a column stride of 2, and a row stride of 2, according to embodiments disclosed herein. The footprints are provided as visual aids for people visualizing convolution. The footprints are 3×3 because the kernel is 3×3. At the top left, the convolution footprint for convolution value 0,0 (a.k.a. o_{0,0}) is shown. The darkened area shows where the kernel is positioned relative to the input frame. For convolution value 0,0, kernel value w_{0,0} and frame value f_{0,0} are positioned together. Similarly, w_{1,1} and f_{1,1} are positioned together, w_{2,2} and f_{2,2} are positioned together, and so forth. To produce the convolution value, each kernel value is multiplied with the frame value it is positioned with. The convolution value is the sum of those multiplication products. For convolution value m,n the kernel has been shifted based on the row and column stride to row (m·Si) and column (n·Sj). As such, for convolution value 0,1 the kernel value w_{0,0} and frame value f_{0,2} are positioned together, w_{1,1} and f_{1,3} are positioned together, w_{2,2} and f_{2,4} are positioned together, etc. As with convolution value 0,0, convolution value 0,1 is the sum of the multiplication products of kernel values and the frame values the kernel values are positioned with. Producing the other convolution values can be similarly visualized by shifting the kernel and accumulating products. The output frame, which depends on the size of the input frame and on the stride size, is 3×3. Therefore, nine convolution values are to be calculated. The footprints for six of those convolution values are shown.

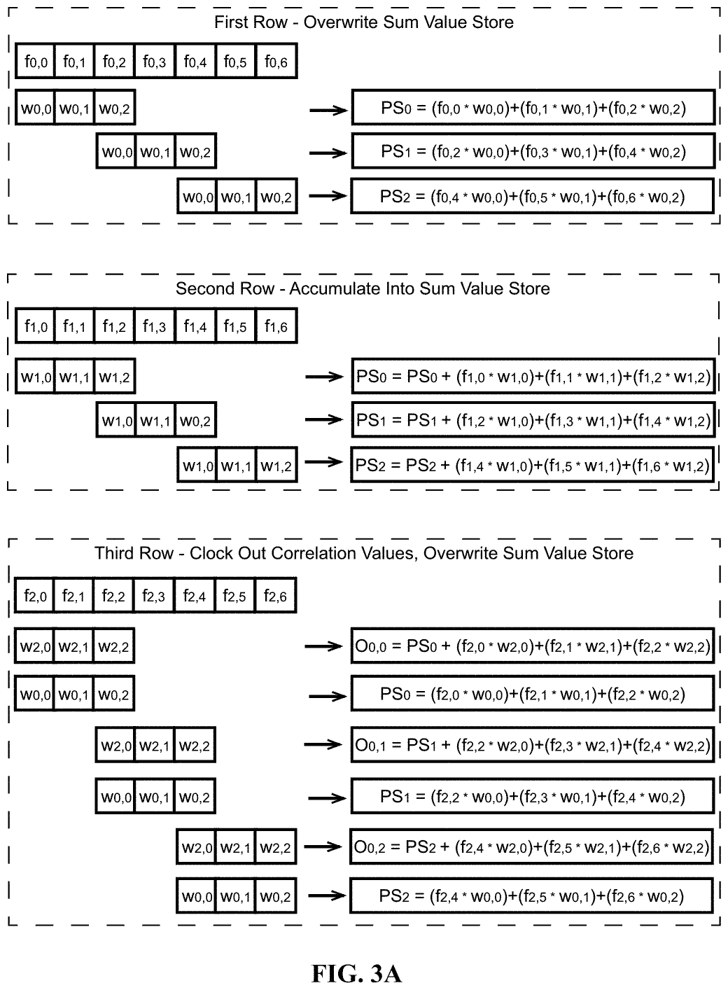

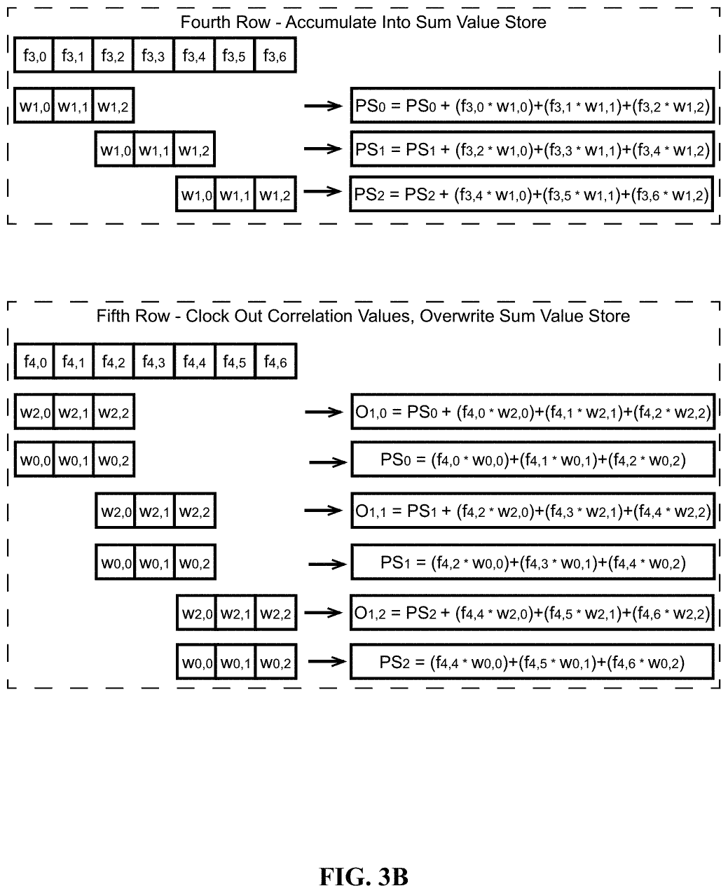

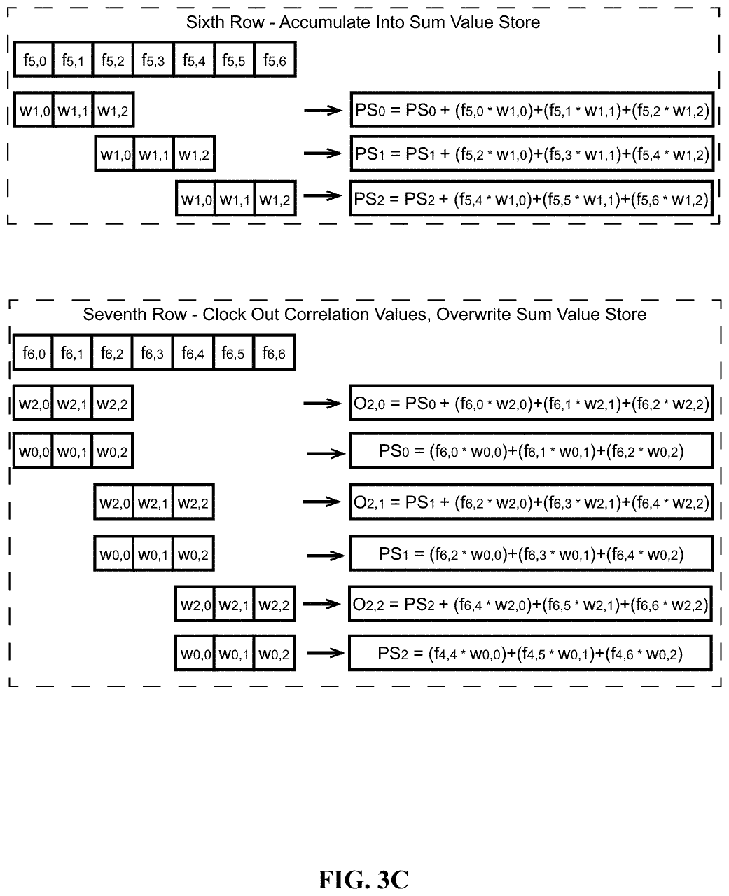

FIG. 3, which includes FIGS. 3A-3C, illustrate operations performed by a minimum memory convolver producing convolution values, according to embodiments disclosed herein. As with FIG. 2, the operations of FIG. 3 are for an example wherein Wi=Wj=3, Fi=Fj=7, and Si=Sj=2. The minimum memory for this application is three memory cells in the sum value store circuit. Nine convolution values are produced. As the input frame is clocked in, the first row of data values are multiplied with the first row of kernel values and stored in the sum value store circuit. As indicated by the “=” sign, the partial sums calculated for the first row of kernel values overwrite whatever was previously stored in the sum value store circuit. The second row of data values are multiplied with the second row of kernel values and added into value stored in the sum value store circuit. As indicated by the “PSx +”, the partial sums calculated for the second row of kernel values are accumulated into the sum value store circuit.

As the third row of the input frame is clocked in, convolution values are clocked out and new partial sums are written into the sum values store. The order of operations can be important because the new partial sums overwrite the previously stored partial sums. Looking to the figure, it is seen that convolution value O_{0,0}=PS₀+(f_{2,0}*w_{2,0})+(f_{2,1}*w_{2,1})+(f_{2,2}*w_{2,2}) which indicates that the previously calculated partial sum is added to the multiplication products for the last kernel row. As soon as it is calculated O_{0,0} can be clocked out of the minimum memory convolver without being stored by the minimum memory convolver. Perhaps in parallel with calculating O_{0,0}, a new partial sum is calculated and stored in the sum value store circuit: PS₀=(f_{2,0}*w_{0,0})+(f_{2,1}*w_{0,1})+(f_{2,2}*w0,2). This new partial sum will be accumulated into convolution value 0,1, O_{0,1}. The critical timing aspect that allows for the reduced memory in the partial sum value store circuit is that the value stored in PS₀ is accumulated into O_{0,0} before PS₀ is overwritten by the new partial sum.

As with the second row of data values, the fourth row of data values are multiplied with the second row of kernel values and added into in the values stored in the sum value store circuit. For the fifth row of data values, as with the third row of data values, convolution values are produced by adding the values in the partial value store circuit to values produced by multiplying the fifth row of data values with the second row of kernel values. The convolution values can be immediately clocked out without being stored. New partial sums based on the fifth row of data values and on the first kernel row are stored in the partial value store circuit and overwrite previous values stored in the partial value store circuit. Operations for the sixth row of data values are similar to those for the second and fourth rows of data values. Operations for the seventh row of data values are similar to those for the third and fifth rows of data values.

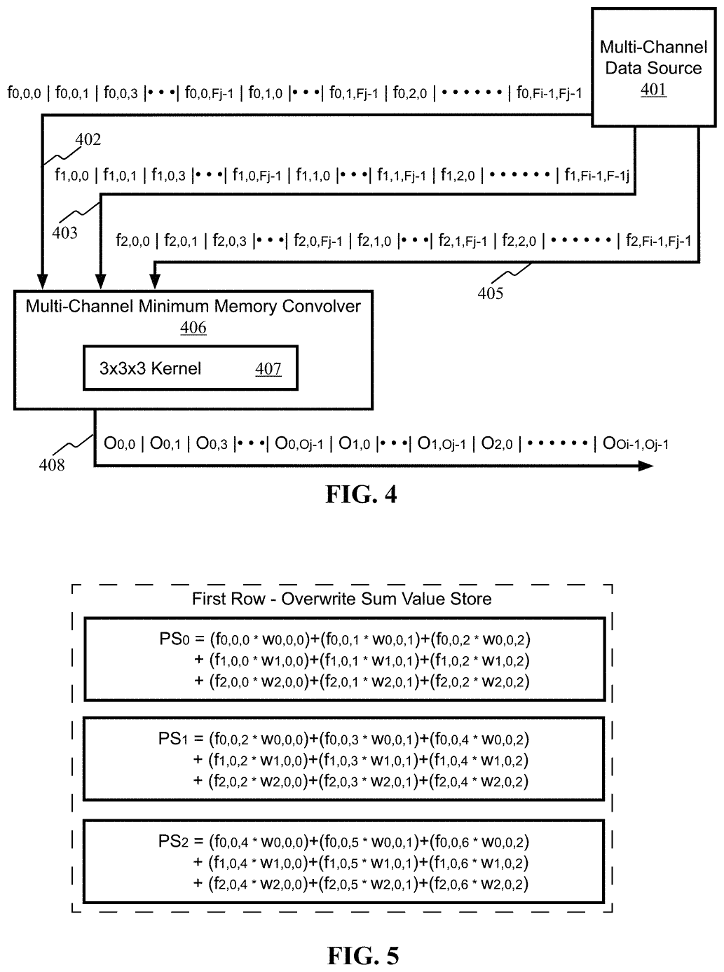

FIG. 4 is a high-level block diagram of a multi-channel minimum memory convolver 406 in operation, according to embodiments disclosed herein. A multi-channel data source 401 can produce three streams of input data values 402, 403, 405. For example, an HD video signal can red, green, and blue channels. Each channel can have a 1080×1920 data frame. The figure uses a f_{k,i,j} nomenclature for the frame values with “k” indicating channel, “i” indicating row, and “j” indicating column. This particular minimum memory convolver 406 convolves the input streams 402, 403, 405 with a 3×3×3 kernel 407. As such, there is a single output channel 408 and the sum value store circuit can be sized based on the Fj and Sj. For example, Mj=960 when Fj=1920 and Sj=2.

FIG. 5 illustrates partial sum calculations for the multi-channel minimum memory convolver of FIG. 4, according to embodiments disclosed herein. The calculations show the first three partial sums calculated as the first row of the three-channel input frame is clocked in. As can be seen, the number of memory cells in the sum value store circuit can be independent of the number input channels. The number of multiplications and additions, however, have more than tripled.

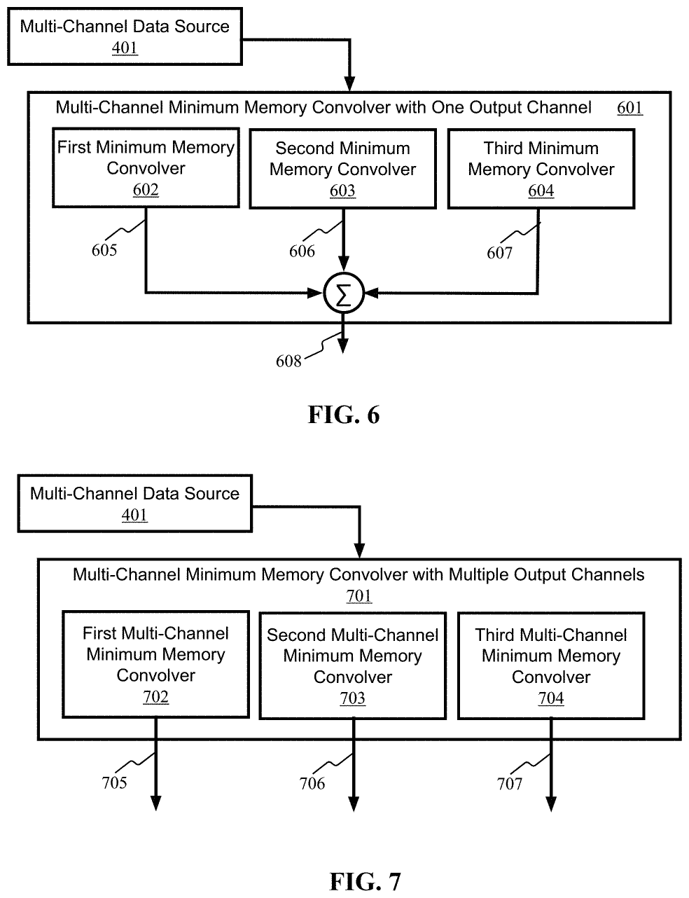

FIG. 6 illustrates a multi-channel minimum memory convolver 601 with one output channel that sums the output of three minimum memory convolvers 602, 603, 604, according to embodiments disclosed herein. The input streams 402, 403, 405 from the multi-channel data source 401 of FIG. 4 can be provided to three different minimum memory convolvers 602, 603, 604. Each of the minimum memory convolvers 602, 603, 604 can process one of the streams 402, 403, 405 to produce output streams 605, 606, 607. A summation circuit 608 can add the output streams 605, 606, 607 together to produce single channel output stream 608.

FIG. 7 illustrates a multi-channel minimum memory convolver 701 with multiple output channels, according to embodiments disclosed herein. All three input streams 402, 403, 405 from the multi-channel data source 401 of FIG. 4 can be provided to three different multi-channel minimum memory convolvers 702, 703, 704. As in FIG. 4, each multi-channel minimum memory convolver produces a single channel output. Multi-channel minimum memory convolver 701 therefor produces three output streams 705, 706, 707.

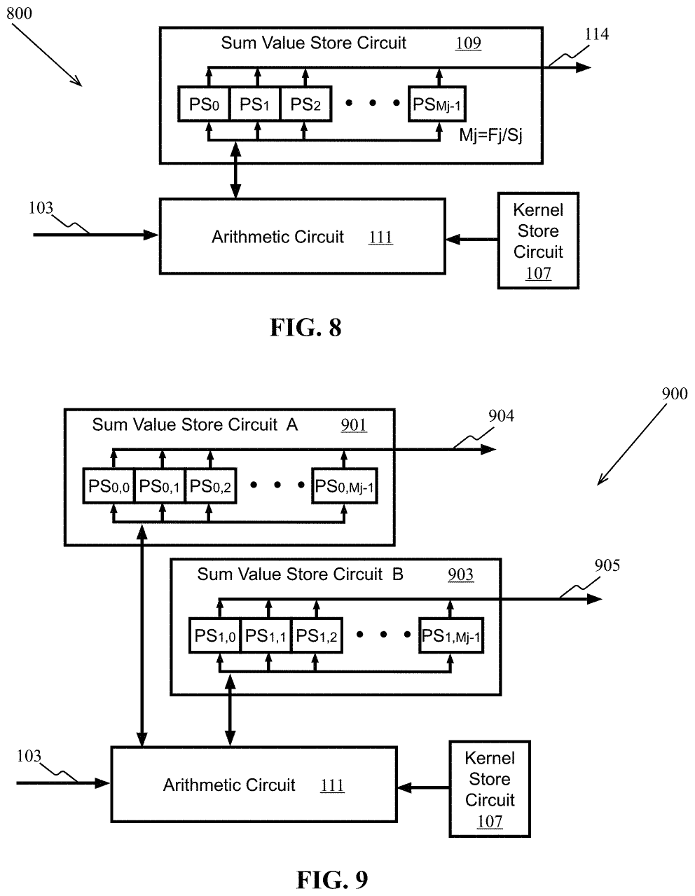

FIG. 8 illustrates a high-level block diagram of a minimum memory convolver 800 with one sum value store circuit 109, according to embodiments disclosed herein. Minimum memory convolver 800 can implement the operations detailed in FIG. 3. The arithmetic circuit can multiply the stream of input data 103 and kernel values from the kernel store circuit 107 and, for some kernel rows, store the products into the sum value store circuit 109. For other kernel rows the products are accumulated into the sum value store circuit 109. The convolution values 114 can be clocked out of the sum value store circuit without being stored in the sum value store circuit 109. Equivalently, the convolution values 114 can be clocked out of the arithmetic circuit, or another circuit, without being stored in the sum value store circuit 109. Certain implementations may store convolution values in the sum value store circuit but must be careful to clock out the convolution values before new partial sums are stored in the memory cells.

FIG. 9 illustrates a high-level block diagram of a minimum memory convolver 901 with two sum value store circuits, according to embodiments disclosed herein. Certain applications can require an additional row of memory cells for storing partial sums. For example, a three-row kernel and Si=1. Recall the example of a 3×3 kernel and Si=2 for which the minimum memory convolver 801 of FIG. 8 can perform the necessary calculations. The minimum memory convolver 901 of FIG. 9 can perform the necessary calculations for the Si=2 example while using only sum value store circuit A 901 or only sum value store circuit B 903. For Si=1, the minimum memory convolver 801 of FIG. 8 can perform the necessary calculations for the even numbered output rows or the odd numbered output rows, but not both. For Si=1, the minimum memory convolver 901 of FIG. 9 can use sum value store circuit A 901 to perform the necessary calculations for the even numbered output rows and can use sum value store circuit B 902 to perform the necessary calculations for the odd numbered output rows. The even numbered output row stream 904 and the odd numbered output row stream 905 can be clocked out without necessarily storing the convolution values in a sum value store circuit 901, 902. Equivalently, the convolution values 904, 905 can be clocked out of the arithmetic circuit, or another circuit, without being stored in the sum value store circuits 901, 902. Certain implementations may store the convolution values in a sum value store circuit but must be careful to clock out the convolution values before new partial sums are stored in the memory cells.

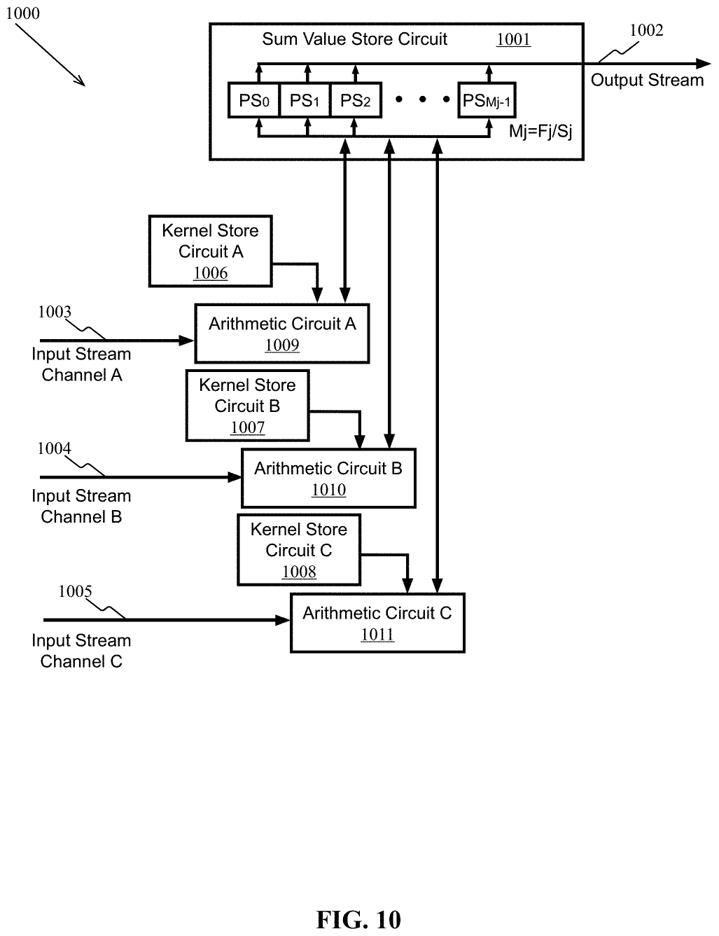

FIG. 10 a high-level block diagram of a minimum memory convolver 1000 with one sum value store circuit 1001 processing multiple input channels 1003, 1004, 1005, according to embodiments disclosed herein. Kernel store circuit A 1006 can store a first channel of kernel values. Kernel store circuit B 1007 can store a second channel of kernel values. Kernel store circuit C 1008 can store a third channel of kernel values. Note that a single kernel store circuit can include kernel store circuit A 1006, kernel store circuit B 1007, and kernel store circuit C 1008. Arithmetic circuit A 1009 can calculate products and partial sums using the first channel of kernel values and input stream channel A 1003. Arithmetic circuit B 1010 can calculate products and partial sums using the second channel of kernel values and input stream channel B 1003. Arithmetic circuit C 1011 can calculate products and partial sums using the third channel of kernel values and input stream channel C 1003. The products and partial sums can be stored and accumulated in sum value store circuit 1001 to produce convolution values 1002. The convolution values 1002 can be clocked out of the sum value store circuit 1001 as an output stream without necessarily storing the convolution values in sum value store circuit memory cell. Equivalently, the convolution values 1002 can be clocked out of an arithmetic circuit 1009, 1010, 1011, or another circuit, without being stored in the sum value store circuit 1001. An additional arithmetic circuit can receive products or partial sums from arithmetic circuits 1009, 1010, 1011 and accumulate or store them into the sum value store circuit 1001. Certain implementations may store the convolution values in a sum value store circuit cell but must clock out the convolution values before new partial sums are stored in the memory cells.

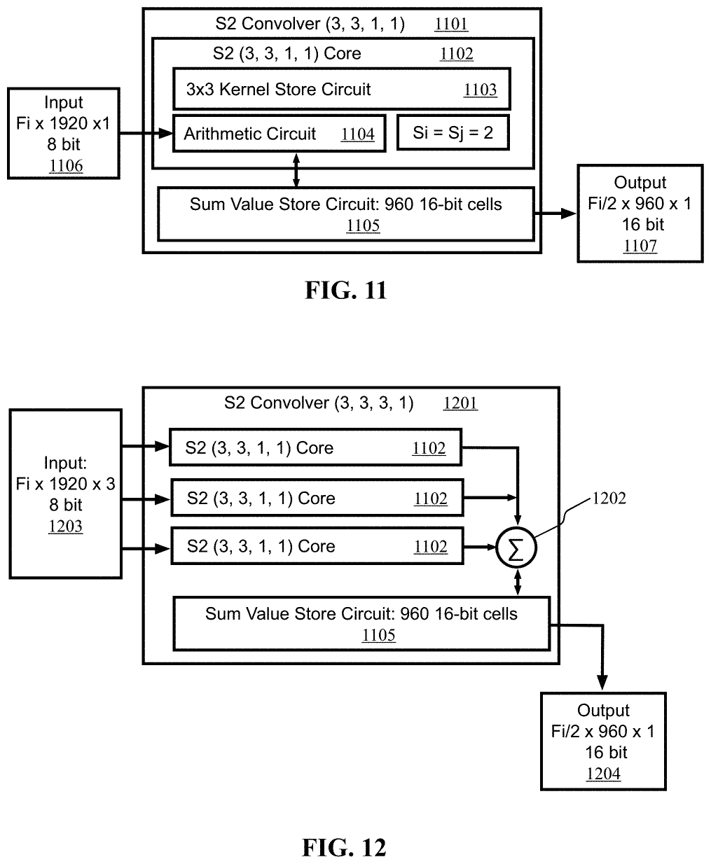

FIG. 11 illustrates an S2 (3, 3, 1, 1) minimum memory convolver 1101, according to embodiments disclosed herein. This particular circuit is designed to convolve a single input channel having 1920 columns 1106 with a 3×3 kernel at a stride of 2 and to produce a 960 column output 1107. This non-limiting example has an S2 (3, 3, 1, 1) core 1102 that works with a 960 cell sum values store 1105. The S2 (3, 3, 1, 1) core 1102 can have a 3×3 kernel store circuit 1103, an arithmetic circuit 1104, and can be designed for Si=Sj=2. The “(3, 3, 1, 1)” term indicates a 3×3 kernel, one input channel, and one output channel. The “S2” term indicates that Si=Sj=2. The circuit of FIG. 8 can implement an S2 (3, 3, 1, 1) minimum memory convolver 1101.

FIG. 12 illustrates an S2 (3, 3, 3, 1) minimum memory convolver 1201, according to embodiments disclosed herein. The S2 (3, 3, 3, 1) minimum memory convolver 1201 is designed for a three channel 1920 column input 1203 and produces a one channel 960 column output 1204. The S2 (3, 3, 3, 1) minimum memory convolver 1201 can contain three S2 (3, 3, 1, 1) cores 1102, each processing one of the input channels. The three S2 (3, 3, 1, 1) cores 1102 can provide results, such as products or sums, to a summation circuit 1202. The summation circuit 1202 can use 960 cell sum value store circuit 1105 to store and accumulate partial sums. The convolution values 1204 can be clocked out of the sum value store circuit 1105 or the summation circuit 1202. The “(3, 3, 3, 1)” term indicates a 3×3 kernel, three input channels, and one output channel.

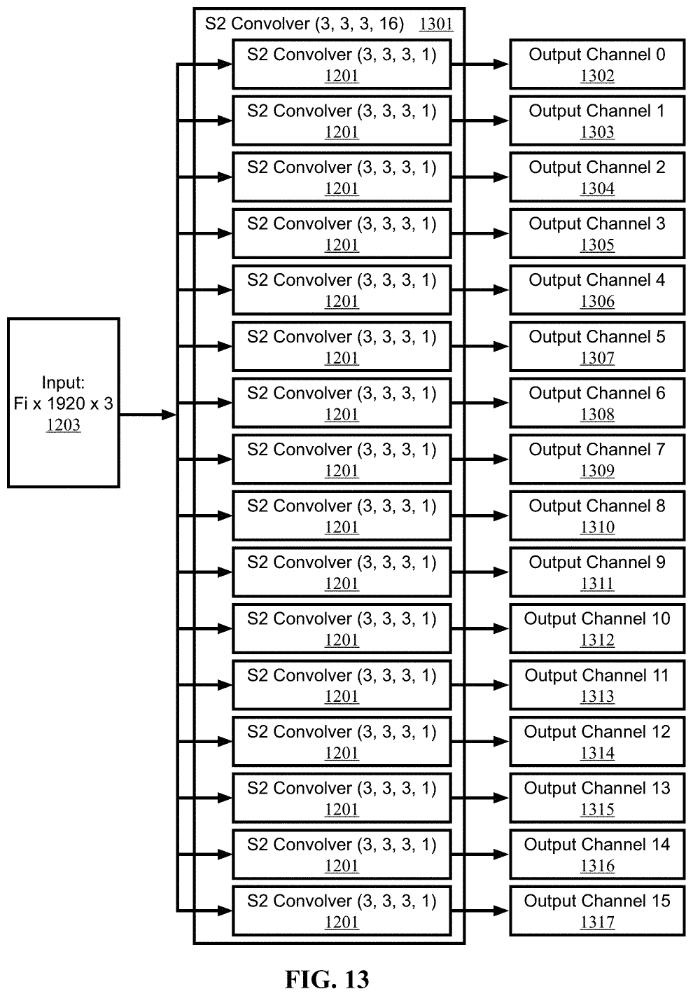

FIG. 13 illustrates an S2 (3, 3, 3, 16) minimum memory convolver 1301, according to embodiments disclosed herein. The S1 (3, 3, 3, 16) minimum memory convolver 1301 is designed for a three channel 1920 column input 1203 and produces a 16 channel 960 column output 1302-1317. The three channel input 1203 can be clocked into 16 different S2 (3, 3, 3, 1) minimum memory convolvers 1201 to produce 16 channels of output data 1302-1317. As can be seen, 16 of the convolvers of FIG. 12 have been combined. The “(3, 3, 3, 16)” term indicates a 3×3 kernel, three input channels, and sixteen output channels.

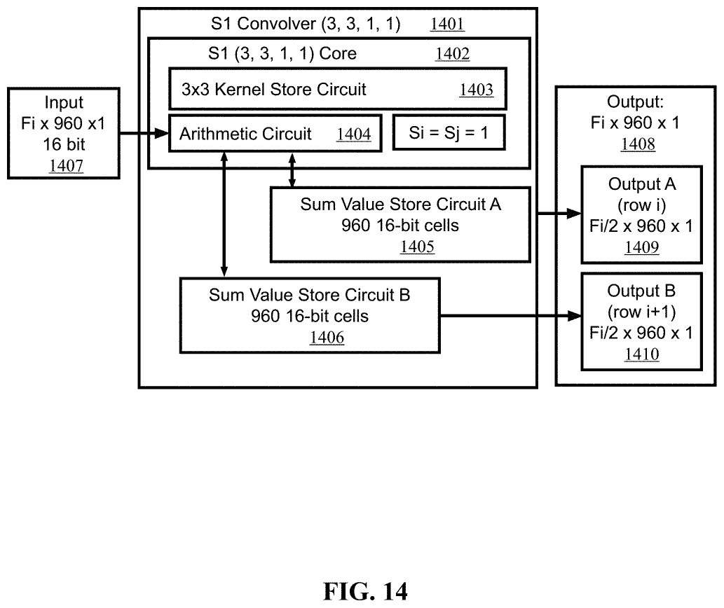

FIG. 14 illustrates an S1 (3, 3, 1, 1) minimum memory convolver 1401, according to embodiments disclosed herein. This particular circuit is designed to convolve a single input channel having 960 columns 1407 with a 3×3 kernel at a stride of 1 and to produce a 960 column output 1408. This non-limiting example has an S1 (3, 3, 1, 1) core 1402 that works with two 960 cell sum values store 1405, 1406. The S1 (3, 3, 1, 1) core 1402 can have a 3×3 kernel store circuit 1403, an arithmetic circuit 1404, and can be designed for Si=Sj=1. The “(3, 3, 1, 1)” term indicates a 3×3 kernel, one input channel, and one output channel. The “S1” term indicates that Si=Sj=1. The circuit of FIG. 9 can implement an S1 (3, 3, 1, 1) minimum memory convolver 1401. Even row convolution values 1409 can be clocked out of sum value store circuit A 1405. Odd row convolution values 1410 can be clocked out of sum value store circuit B 1406. The output 1408 includes the even row convolution values 1409 and the odd row convolution values 1410.

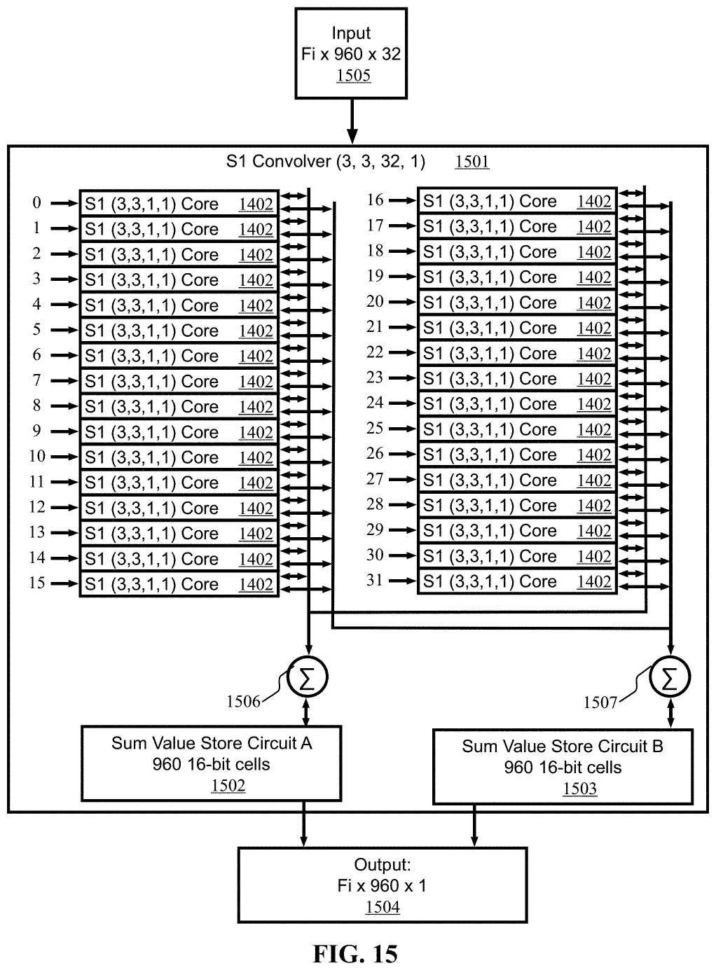

FIG. 15 illustrates an S1 (3, 3, 32, 1) minimum memory convolver 1501, according to embodiments disclosed herein. The S1 (3, 3, 32, 1) minimum memory convolver 1501 is designed for a 32 channel 960 column input 1505 and produces a one channel 960 column output 1504. The S2 (3, 3, 32, 1) minimum memory convolver 1501 can contain 32 S1 (3, 3, 1, 1) cores 1402, each processing one of the input channels. The 32 S1 (3, 3, 1, 1) cores 1402 can provide results, such as products or sums, to summation circuits 1506, 1507. The summation circuits 1506, 1507 can use 960 cell sum value store circuits 1502, 1503 to store and accumulate partial sums. The convolution values 1504 can be clocked out of the sum value store circuits 1502, 1503 or the summation circuits 1506, 1507. The “(3, 3, 32, 1)” term indicates a 3×3 kernel, 32 input channels, and one output channel.

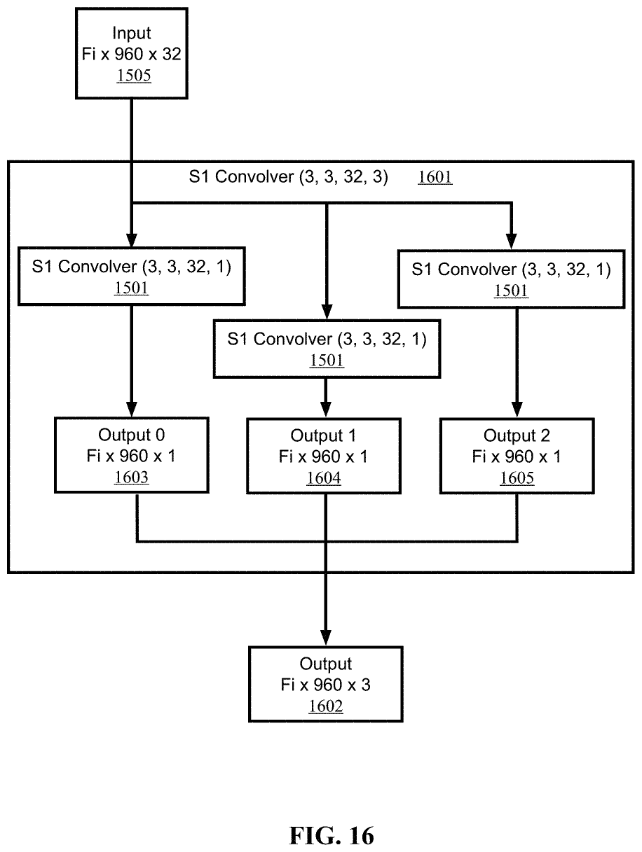

FIG. 16 illustrates an S1 (3, 3, 32, 3) minimum memory convolver 1601, according to embodiments disclosed herein. The S1 (3, 3, 32, 3) minimum memory convolver 1501 is designed for a 32 channel 960 column input 1505 and produces a three channel 960 column output 1602. The 32 channel input 1505 can be clocked into 3 different S1 (3, 3, 32, 1) minimum memory convolvers 1501 to produce 3 channels of output data 1603-1605. As can be seen, three of the convolvers of FIG. 15 have been combined. The “(3, 3, 32, 3)” term indicates a 3×3 kernel, 32 input channels, and three output channels.

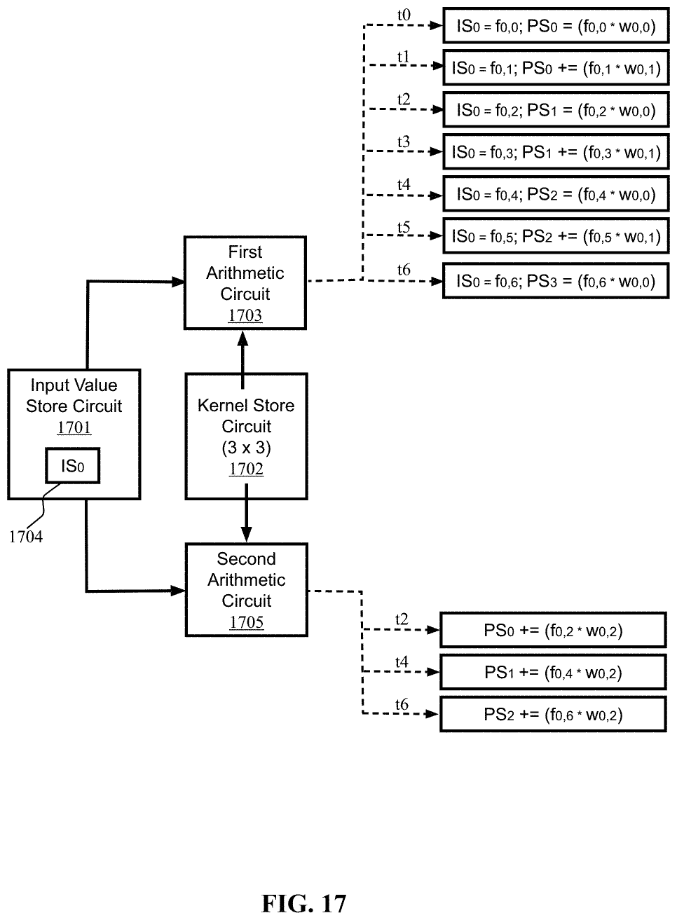

FIG. 17 illustrates a single cell input value store circuit 1704 and two arithmetic circuits 1703, 1705 processing data values, according to embodiments disclosed herein. Other embodiments may use a single arithmetic circuit that is faster or otherwise able to perform all the required calculations. The purpose of this non-limiting figure is to illustrate data values being clocked in through an input value store circuit 1701. In this non-limiting example, the kernel stored in the kernel value store circuit 1702 has 3 columns and the convolution column stride Sj=2. At time t0, the data value f_{0,0} is clocked in and latched into or stored by memory cell IS₀ 1704. Also, at time t0, the first partial sum is calculated by the first arithmetic circuit 1703 and stored in the sum value store circuit: PS₀=(f_{0,0}*w_{0,0}), which overwrites whatever value was previously stored in PS₀. At time t1, the next data value is clocked in and another product is calculated by the first arithmetic circuit 1703 and is accumulated into the sum value store circuit: IS₀=f_{0,1}; PS₀+=(f_{0,1}*w_{0,1}). As before, “+=” indicates that the value to the right of “+=” is added into the variable on the left of the “+=”. “+=” is sometimes called an accumulation operator.

At time t2, f_{0,2} is clocked in and latched into or stored by memory cell IS₀ 1704: IS₀=f_{0,2}. f_{0,2} is used in two different calculations because it is used in calculating both o_{0,0} and o_{0,1}. For this reason, two arithmetic circuits can be used. The first arithmetic circuit can perform the operation: PS₁=(f_{0,2}*w_{0,0}), which overwrites whatever value was previously stored in PS₁. In parallel, the second arithmetic circuit 1705 can perform the operation: PS₀+=(f_{0,2}*w_{0,2}), accumulating another product into PS₀. At time t3, f_{0,3} is clocked in: IS₀=f_{0,3}, and the first arithmetic circuit 1703 performs the operation: PS₁+=(f_{0,3}*w_{0,1}). At time t4, f_{0,4} is clocked in: IS₀=f_{0,4}, the first arithmetic circuit 1703 performs the operation: PS₂=(f_{0,4}*w_{0,0}), and the second arithmetic circuit 1705 performs the operation: PS₁+=(f_{0,4}*w0,2). At time t5, f_{0,5} is clocked in: IS₀=f_{0,5}, and the first arithmetic circuit 1703 performs the operation: PS₂+=(f_{0,5}* w_{0,1}). At time t6, f_{0,6} is clocked in: IS₀=f_{0,6}, the first arithmetic circuit 1703 performs the operation: PS₃=(f_{0,6}*w_{0,0}), and the second arithmetic circuit 1705 performs the operation: PS₂+=(f_{0,6}*w_{0,2}).

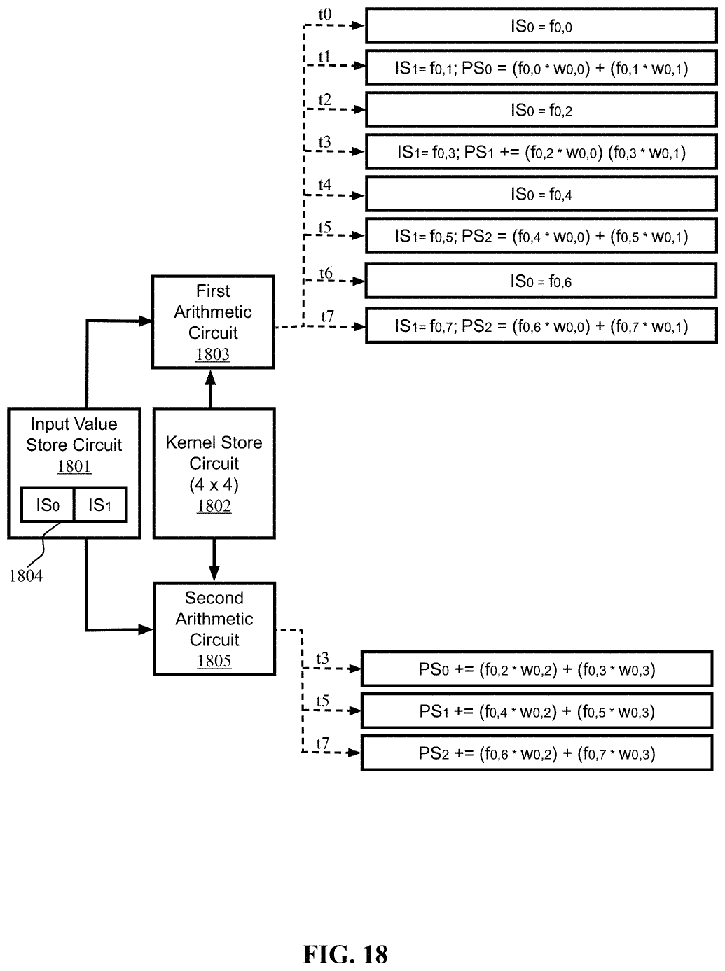

FIG. 18 illustrates a two cell input value store circuit 1801 and two arithmetic circuits 1803, 1805 processing data values, according to embodiments disclosed herein. Other embodiments may use a single arithmetic circuit that is faster or otherwise able to perform all the required calculations. The purpose of this non-limiting figure is to illustrate strides of data values being clocked in through an input value store circuit 1801. In this non-limiting example, the kernel stored into the kernel value store circuit 1802 has 4 columns and the convolution row stride Sj=2. The row stride being 2 and the input value store circuit storing a stride of data values at a time, the input value store circuit 1801 has two memory cells 1804: IS₀ and IS₁.

At time t0, f_{0,0} is clocked in: IS₀=f_{0,0}. At time t1, f_{0,1} is clocked in: IS₁=f_{0,1}. and the first arithmetic circuit 1803 performs the operation: PS₀=(f_{0,0}*w_{0,0})+(f_{0,1}*w_{0,1}). Note that other embodiments may use shift registers such that at time t1 f_{0,0} is shifted into IS₁ and IS₀ receives the new data value, f_{0,1}. At time t2, f_{0,2} is clocked in: IS₀=f_{0,2}. At time t3, f_{0,3} is clocked in: IS₁=f_{0,3}, the first arithmetic circuit 1803 performs the operation: PS₁=(f_{0,2}*w_{0,0})+(f_{0,3}*w_{0,1}), and the second arithmetic circuit 1805 performs the operation: PS₀=(f_{0,2}*w_{0,2})+(f_{0,3}*w_{0,3}). At time t4, f_{0,4} is clocked in: IS₀=f_{0,4}. At time t5, f_{0,5} is clocked in: IS₁=f_{0,5}, the first arithmetic circuit 1803 performs the operation: PS₁=(f_{0,4}*w_{0,0})+(f_{0,5}*w_{0,1}), and the second arithmetic circuit 1805 performs the operation: PS₀=(f_{0,4}*w_{0,2})+(f_{0,5}*w_{0,3}). At time t6, f_{0,6} is clocked in: ISₒ=f_{0,6}. At time t7, f_{0,7} is clocked in: IS₁=f_{0,7}, the first arithmetic circuit 1803 performs the operation: PS₁=(f_{0,6}*w_{0,0})+(f_{0,7}*w_{0,1}), and the second arithmetic circuit 1805 performs the operation: PS₀=(f_{0,6}*w_{0,2})+(f_{0,7}*w_{0,3}).

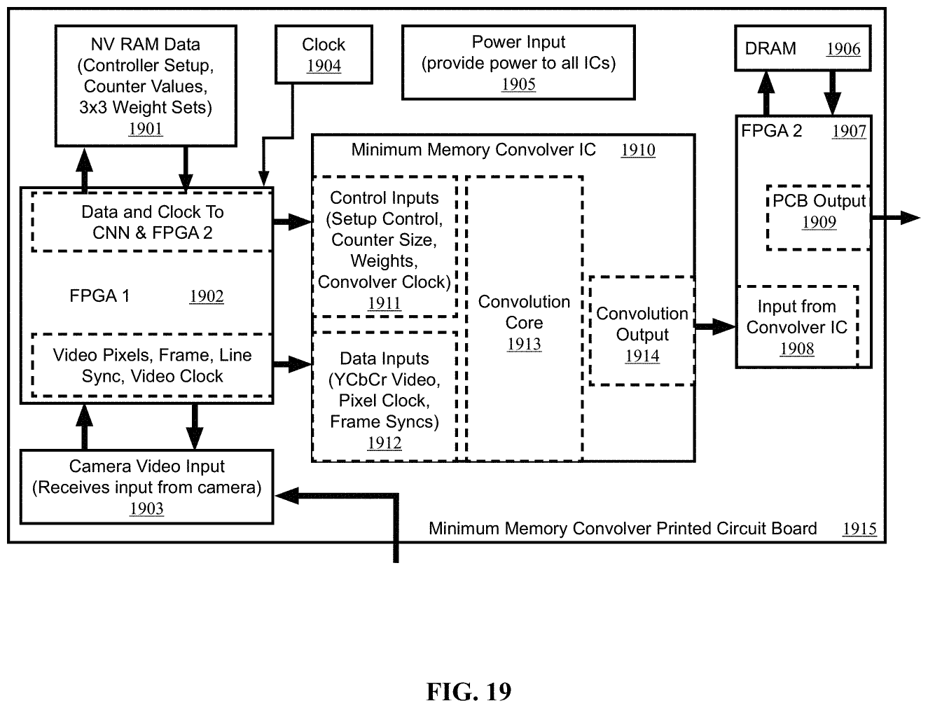

FIG. 19 illustrates a system diagram of a minimum memory convolver printed circuit board (PCB) 1915 having a minimum memory convolver integrated circuit (IC) 1910. A power input 1905 can receive electrical power from an outside source and can provide electrical power to the circuits and ICs on the PCB 1915. A clock 1904 can provide clock signals to field programmable gate array 1 (FPGA 1) 1902 and other circuits and ICs on the PCB 1915. A camera video input 1903 can receive input from a camera or other video source. For example, the video input can be can be an H.264 decoder chip or one of the other video input chips familiar to those experienced in video hardware design. A data bus between the video input 1903 and FPGA 1 1902 can carry pixel data, frame signals, line synchronization signals, a video clock signal, and other signals and data. FPGA 1 1902 can process the signals from the video input 1903 and produce frame data signals for the minimum memory convolver IC 1910. FPGA 1 1902 can also contain circuitry for initializing and controlling the minimum memory convolver IC 1910. A non-volatile random-access memory (RAM) chip 1901 can store data needed for initializing and running the minimum memory convolver IC 1910. That data includes controller set up data, counter values, and convolution kernels. The convolution kernels can be 3×3 convolution kernels. FPGA 2 1907 can have an input section 1908 that receives convolution outputs and other signals from the minimum memory convolver IC 1910. An output section 1909 of FPGA 2 1907 can condition the signals from the minimum memory convolver IC 1910 for off board transmission.

The minimum memory convolver IC 1910 can be initialized and controlled by FPGA 1 1902 and can receive an input data stream from FPGA 1 1902. The minimum memory convolver IC 1910 can send convolution output data and other signals to FPGA 2 1907. The functions of the FPGAs can be performed by more or fewer FPGAs, by application specific ICs (ASICs), or other chips. As such, the chips exterior to the minimum memory convolver IC 1910 are non-limiting with respect to the embodiments unless specifically claimed.

The minimum memory convolver IC 1910 can have a control section 1911 that can write kernels into the convolvers in the convolution core 1913 and can otherwise set up the convolution core 1913 such that it processes the input data stream it receives from the data input section 1912. The convolution core 1913 can include one or more of the minimum memory convolvers of FIGS. 1, 6-16. As discussed above, the minimum memory convolvers of FIGS. 1, 6-16 can be combined to produce more complex convolvers. In addition, the minimum memory convolvers of FIGS. 1, 6-16 can be chained such that the output of one convolver is the input to another convolver. The convolution core 1913 therefor process the input data stream and produces convolution outputs. The convolution outputs are useful in many applications including video compression, pattern recognition, and convolutional neural networks.

The minimum memory convolver printed circuit board (PCB) 1915 can be deployed as a component in an embedded system or consumer product. It can be used in any machine having a camera (or camera input), that convolves the video with convolution kernels, and may perform further processing to produce image processing results, pattern recognition results, etc. One simple example is that the convolver core can use an edge detector kernel and thereby produce, in real time, a video stream showing the edges of the input video stream. The minimum memory convolver disclosed herein is a key aspect in reducing the size and power requirements of systems using minimum memory convolver subsystems such as minimum memory convolver PCB 1915 or minimum memory convolver IC 1910.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A system, the system configured for convolving an input stream of data with a kernel, the system comprising:
a kernel store circuit configured to store the kernel, the kernel comprising a plurality of kernel values arranged as Wi rows of kernel values and Wj columns of kernel values, wherein Wi is greater than one;
an arithmetic circuit configured to calculate a plurality of partial sums, each calculated using at least one data value and at least one of the plurality of kernel values, wherein the input stream of data comprises the at least one data value;
a sum value store circuit configured to store the plurality of partial sums and to clock out a plurality of convolution values, wherein each one of the plurality of convolution values is calculated at least in part using a first row kernel value and a last row kernel value.

2. The system of claim 1:
wherein the input stream of data is convolved with the kernel at a column stride of Sj,
wherein the input stream of data comprises Fj columns of data values, and
wherein the sum value store circuit contains no more than ceil(Fj/Sj) memory registers.

3. The system of claim 1 further comprising:
an input circuit configured to receive the input stream of data, the input stream of data comprising Fi rows of data values and Fj columns of data values, wherein the input stream of data is received row-by-row as a stream of data values;
an output circuit configured to output the plurality of convolution values,
wherein the plurality of convolution values comprises a plurality of first row partial sums and a plurality of last row partial sums, wherein the plurality of first row partial sums are calculated using a first kernel row, and wherein the plurality of last row partial sums are calculated using a last kernel row, and
wherein the plurality of first row partial sums overwrite the plurality of partial sums stored in the sum value store circuit.

4. The system of claim 3 wherein the plurality of last row partial sums is not accumulated into the sum value store circuit.

5. The system of claim 1 further comprising an input value store circuit configured to store the at least one data value, wherein the arithmetic circuit receives the at least one data value from the input value store circuit.

6. The system of claim 5 further comprising a second arithmetic circuit configured to calculate a plurality of additional values comprising an additional value calculated using the kernel and at least one subsequent data value, wherein a first partial sum is calculated using the kernel and at least one preceding data value, wherein the at least one subsequent data value overwrites the at least one preceding data value in the input value store circuit, and wherein one of the plurality of convolution values is based at least in part on the first partial sum and the additional value.

7. The system of claim 5 wherein one of the plurality of partial sums is based at least in part on a first partial sum and an additional value, the first partial sum calculated using at least one preceding data value and the additional value calculated using at least one subsequent data value, wherein the at least one subsequent data value overwrites the at least one preceding data value in the input value store circuit.

8. The system of claim 5 further comprising:
wherein the input stream of data comprises Fi rows of data values and Fj columns of data values, p1 wherein the kernel comprises Wi rows of kernel values and Wj columns of kernel values,
wherein the input stream of data is convolved with the kernel at a column stride of Sj and a row stride of Si,
wherein Si=2, Sj=2, Wi=3, and Wj=3, Fj=1920, and Fi=1080,
wherein the kernel comprises a first kernel row, a second kernel row, a third kernel row, a first kernel column, a second kernel column, and a third kernel column,
wherein the sum value store circuit contains no more than ceil(Fj/Sj) memory registers;
wherein the input value store circuit contains Sj memory registers configured to sequentially store a plurality of strides, each stride comprising two data values,
wherein a plurality of first row partial sums is calculated using the plurality of strides and the first two columns of the first kernel row,
wherein a plurality of second row partial sums is calculated using the plurality of strides and the first two columns of the second kernel row,
wherein a plurality of last row partial sums is calculated using the plurality of strides and the first two columns of the third kernel row,
wherein each of the plurality of convolution values are calculated using one of the first row partial sums, one of the plurality of second row partial sums, and one of the plurality of last row partial sums, and
wherein the arithmetic circuit calculates a plurality of additional values comprising an additional value calculated using a third kernel column and a first column of a plurality of subsequent strides.

9. The system of claim 5 wherein the arithmetic circuit sums a first partial sum and an additional value calculated using a subsequent stride, wherein a first partial sum is calculated using a preceding stride, and wherein the subsequent stride overwrites the preceding stride in the input value store circuit.

10. The system of claim 1 further comprising:
a second kernel store circuit configured to store a second kernel channel; and
a third kernel store circuit configured to store a third kernel channel,
wherein the input stream of data comprises a second input channel and a third input channel,
wherein the arithmetic circuit is configured to produce a second plurality of partial sums based on the second kernel channel and the second input channel,
wherein the arithmetic circuit is configured to produce a third plurality of partial sums based on the third kernel channel and the third input channel, and
wherein the second plurality of partial sums and the third plurality of partial sums are added to the plurality of partial sums stored in the sum value store circuit.

11. The system of claim 10 wherein the kernel further comprises a kernel output channel 795 wherein a flattened output frame comprises a plurality of flattened output values, wherein each flattened output value is based at least in part on a first output channel value, a second output channel value, a third output channel value, and the kernel output channel.

12. The system of claim 1:
wherein the input stream of data comprises a plurality of input channels;
wherein the kernel comprises a plurality of kernel channels;
wherein the kernel store circuit is configured to store the plurality of kernel channels;
wherein the arithmetic circuit is configured to produce the plurality of convolution values using each one of the plurality of input channels and each one of the plurality of kernel channels.

13. A system, the system configured for convolving an input stream of data with a kernel at a column stride of Sj and a row stride of Si, the system comprising:
an input circuit configured to receive the input stream of data, the input stream of data comprising Fi rows of data values and Fj columns of data values, wherein the input stream of data is received row-by-row as a stream of data values;
a kernel store circuit configured to store the kernel, the kernel comprising a plurality of kernel values arranged as Wi rows of kernel values and Wj columns of kernel values, wherein Wi is greater than one;
an arithmetic circuit configured to calculate a plurality of partial sums, each calculated using at least one data value stored in an input value store circuit and at least one of the plurality of kernel values, wherein the input stream of data comprises the at least one data value;
a sum value store circuit configured to store the plurality of partial sums and to clock out a plurality of convolution values, wherein each one of the plurality of convolution values is calculated at least in part using a first row kernel value and a last row kernel value; and
an output circuit configured to output the plurality of convolution values.

14. The system of claim 13 wherein the input value store circuit is configured to store Sj data values at once and wherein the input value store circuit contains no more than Sj memory registers.

15. A system, the system configured for convolving an input stream of data with a kernel, the system comprising:
a kernel store circuit configured to store the kernel, the kernel comprising 3 rows of kernel values and 3 columns of kernel values;
an arithmetic circuit; and
a sum value store circuit configured to store a plurality of partial sums and to clock out a plurality of convolution values;
wherein the arithmetic circuit calculates a plurality of row 0 partial sums using the input stream of data and kernel row 0,
wherein the plurality of row 0 partial sums is stored in the sum value store circuit by overwriting a previous plurality of partial sums previously stored in the sum value store circuit,
wherein the arithmetic circuit calculates a plurality of row 1 partial sums using the input stream of data and kernel row 1,
wherein the plurality of row 1 partial sums is accumulated into to the plurality of partial sums stored in the sum value store circuit,
wherein the arithmetic circuit calculates a plurality of row 2 partial sums using the input stream of data and kernel row 2,
wherein the plurality of row 2 partial sums is added to the plurality of partial sums to produce the plurality of convolution values.

16. The system of claim 15 wherein clocking out the plurality of convolution values is performed in parallel with storing a subsequent plurality of row 0 partial sums in the sum value store circuit.

17. The system of claim 15 further comprising:
an input circuit configured to receive the input stream of data, the input stream of data comprising a plurality of input columns of data values;
a stride store circuit configured to sequentially store a plurality of length two strides from the input stream of data, wherein a preceding stride is from input columns n and n+1, wherein a subsequent stride is from input columns n+2 and n+3, and wherein the subsequent stride overwrites the preceding stride stored in the stride store circuit; and
an output circuit configured to output the plurality of convolution values,
wherein the stride store circuit provides the plurality of length two strides to the arithmetic circuit.

18. The system of claim 15 wherein the plurality of input columns of data values is Fj input columns and wherein the sum value store circuit is configured to store no more than ceil(Fj/2) partial sums at a time.

19. The system of claim 15 wherein one of the plurality of partial sums is based at least in part on a row 0 partial sum and an additional value, the row 0 partial sum calculated using a preceding stride and the additional value calculated using a subsequent stride, wherein a subsequent stride overwrites the preceding stride in a stride store circuit.

20. The system of claim 15 wherein the arithmetic circuit is configured to add an additional value to a partial sum, the partial sum calculated using a preceding stride, the additional value calculated using a subsequent stride that overwrites the preceding stride in a stride store circuit.
